(19) United States
(12) Patent Application Publication
(10) Pub. No.: US 2008/0203667 A1
(43) Pub. Date: Aug. 28, 2008

(54) Candle domino

(76) Inventor: Hun Yan Fung, Fo Tan (HK)

Correspondence Address: Raymond Y. Chan, Suite 128, 108 N. Ynez Avenue, Monterey Park, CA, 91754, US

(21) Appl. No.: 11/999,920

(22) Filed: Dec. 6, 2007

Related U.S. Application Data
(63) Continuation-in-part of application No. 11/710,005, filed on Feb. 23, 2007.

(51) Int. Cl. A63F 9/20; A63F 11/00; C11C 5/00

(52) U.S. Cl. 273/295; 273/287; 431/288

(57) ABSTRACT

A set of candle dominoes includes a domino playground and a plurality of domino members. The domino playground has a playing area and includes a plurality of holding seats. The domino members are erected on the playing area in predetermined domino sequence to define a starter domino member and a final domino member, wherein each of the domino members includes a wax-made domino body sitting at the corresponding holding seat and an ignition rope upwardly extended from a top surface of the domino body for being ignited to produce an illumination effect, wherein the holding seats initially hold the domino member at an upright position and allow the domino member to be toppled, wherein when the starter domino member is toppled to hit an adjacent domino member until the final domino member is toppled, the domino members are sequentially brought down by the previous domino members.

### CROSS REFERENCE OF RELATED APPLICATION

This is a Continuation-In Part application of a non-provisional application having an application number Ser. No. 11/710,005, and a filing date of Feb. 23, 2007.

### BACKGROUND OF THE PRESENT INVENTION

1. Field of Invention

The present invention relates to dominoes, and more particularly to a candle dominoes set which is capable of producing an illumination domino pattern when the dominoes are sequentially toppled.

2. Description of Related Arts

A conventional domino set usually comprises a plurality of domino tiles spacedly erected in a predetermined playing area in a specific sequence in such a manner that when the first domino tile is toppled to push against the adjacent domino tile, all the domino tiles will be sequentially toppled and fall onto the playing area. When the domino tiles are falling in that specific sequence, a domino pattern is formed and in many circumstances, this domino pattern reflects a specific aesthetic pattern for particular purposes, such as promotion of specific logos or campaigns. In many occasions, some sorts of campaigns are organized by many organizations in which the longest chain of domino tiles is sought.

Despite their popularity, domino games have encountered several limitations. First, the range of aesthetic patterns formed by conventional domino sequences is indeed very limited. The most one can do is to colorfully decorate each of the domino tiles so that when they are erected in the playing area, the colorfully decorated domino tiles stand to give a predetermined aesthetic pattern corresponding to the decoration. However, when the tiles are sequentially toppled, the domino tiles may not form any aesthetic pattern at all, especially when one is trying to observe the entire toppling pattern from a distance.

Second, several suggestions have been formed to enhance the aesthetic appearance of domino tiles. For example, one may think of making the domino tiles to generate illumination for enhancing the overall domino pattern. The problem for this suggestion is that to incorporate some sorts of electric illuminating device to every single piece of domino tile would be very expensive, in that in a typical domino game, there may involve hundreds or thousands of domino tiles with the corresponding number of electricity supplies. As a result, from a practical point of view, it is almost impossible to produce a domino set having all of the domino tiles illuminating.

### SUMMARY OF THE PRESENT INVENTION

A main object of the present invention is to provide a candle dominoes set which is capable of producing an illumination domino pattern when the dominoes are sequentially toppled.

Another object of the present invention is to provide a candle dominoes set comprising a plurality of wax-made domino members, wherein each of the domino members can act as an energy source for providing illumination through ignition of the wax-made domino body.

Another object of the present invention is to provide a candle dominoes set comprising a plurality of wax-made domino members, wherein each of the domino members can act as an energy source for providing illumination for that corresponding domino member so as to substantially resolve the energy supply problem as mentioned in the conventional domino sets.

Another object of the present invention is to provide a candle dominoes set which is designed to operate in a carefully designed and controlled domino playground so as to produce an optimal domino pattern when the domino members are sequentially toppled.

Accordingly, in order to accomplish the above objects, the present invention provides a set of candle dominoes, comprising:

a domino playground having a playing area and comprising a plurality of holding seats spacedly provided therewithin; and

a plurality of domino members spacedly erected on the playing area in predetermined domino sequence to define a starter domino member as the first of the domino sequence and a final domino member as the end of the domino sequence, wherein each of the domino members comprises a wax-made domino body sitting at the corresponding holding seat and an ignition rope upwardly extended from a top surface of the domino body for being ignited to produce an illumination effect, wherein the holding seats initially hold the domino member at an upright position and allow the domino member to be toppled at any direction, wherein when the starter domino member is toppled to hit an adjacent domino member until the final domino member is toppled, the domino members are sequentially brought down by the previous domino members to form a predetermined illumination domino pattern on the domino playground.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a candle domino set according to a preferred embodiment of the present invention.

FIG. 2 is a schematic diagram of the candle domino set according to the above preferred embodiment of the present invention.

FIG. 3A to FIG. 3C are schematic diagrams of the domino playground according to the above preferred embodiment of the present invention.

FIG. 4 is a first alternative mode of the domino playground of the domino member of the candle domino set according to the above preferred embodiment of the present invention.

FIG. 5A to FIG. 5H are schematic diagrams of a second alternative mode of the domino playground of the domino member of the candle domino set according to the above preferred embodiment of the present invention.

FIG. 6A to FIG. 6H are schematic diagrams of a third alternative mode of the candle domino set according to the above preferred embodiment of the present invention.

FIG. 7A to FIG. 7B are schematic diagrams of a fourth alternative mode of the candle domino set according to the above preferred embodiment of the present invention.

FIG. 8 is a fifth alternative mode of the candle domino set according to the above preferred embodiment of the present invention.

### DETAILED DESCRIPTION OF THE PREFERRED EMBODIMENT

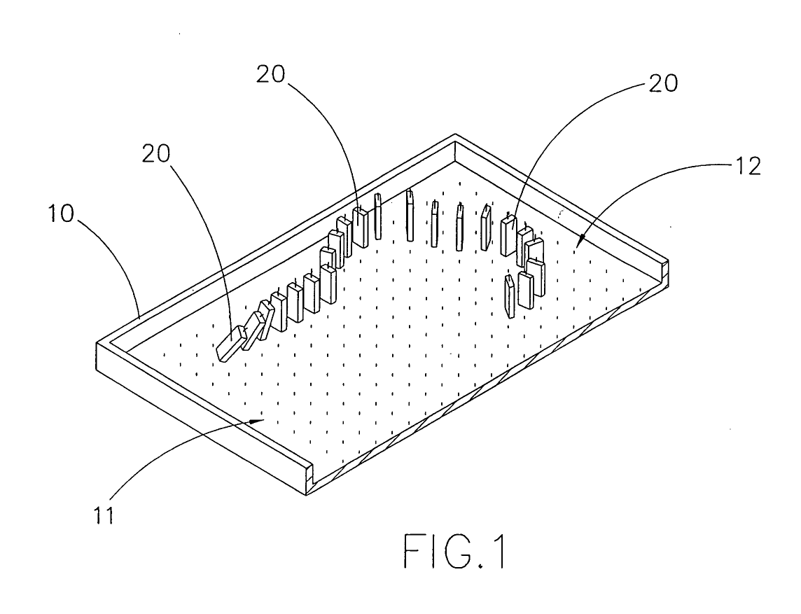

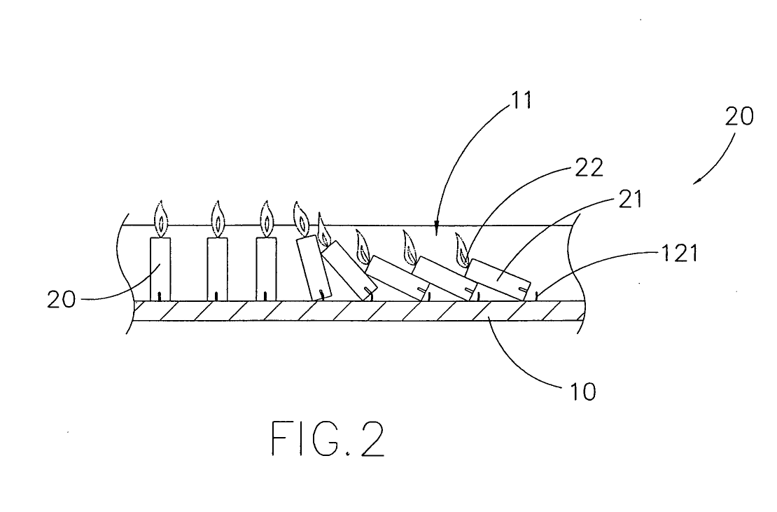

Referring to FIG. 1 to FIG. 2 of the drawings, a set of candle dominoes according to a preferred embodiment of the present invention is illustrated, in which the candle dominoes set comprises a domino playground 10 and a plurality of domino members 20.

The domino playground 10 has a playing area 11 having an optionally fire-proof feature, and comprises a plurality of holding seats 12 spacedly provided therewithin. Accordingly, the domino playground 10 is a portable playground for the player to easily carry and set up to play the domino members 20 in a safety manner.

The domino members 20 are spacedly erected on the playing area 11 in predetermined domino sequence to define a starter domino member 20 as the first of the domino sequence and a final domino member 20 as the end of the domino sequence, wherein each of the domino members 20 comprises a wax-made domino body 21 sitting at the corresponding holding seat 12, and at least one ignition element 22 upwardly extended from a top surface 211 of the domino body 21 for being ignited to produce an illumination effect, wherein the holding seats 12 initially hold the domino member 20 at an upright position and allow the domino member 20 to be toppled at any direction, wherein when the starter domino member 20 is toppled to hit an adjacent domino member 20 until the final domino member 20 is toppled, the domino members 20 are sequentially brought down by the previous domino members 20 to form a predetermined illumination domino pattern on the domino playground 10.

According to the preferred embodiment of the present invention, the domino playground 10 is for designating a particular area in which the domino members 20 are erected and subsequently toppled. The fireproof playing area 11 is designed and crafted to prevent fire from spreading out therefrom so as to ensure outmost safety when a user is playing the candle dominoes of the present invention. Moreover, the fireproof playing area 11 also ensures that onlookers of the dominoes games will be safe.

Each of the holding seats 12 comprises a flexible holding pin 121 for detachably and movable connected with a bottom surface of the corresponding domino body 21 of each of the domino members 20, in such a manner that when the domino member 20 is erected on the fireproof playing area 11, the flexible holding pin 121 assists in retaining the domino members 20 in position, and when the domino members 20 are sequentially toppled to form the domino pattern, the flexible holding pin 121 is adapted to be pivotally moved for allowing unimpaired toppling of the corresponding domino member 20. Thus, a distance between every two said adjacent flexible holding pins 121 is smaller than a height of each of said domino bodies 21. In addition, each of the flexible holding pins 21, which is made of fireproof material, has a height relatively smaller than a height of each of the domino bodies 21.

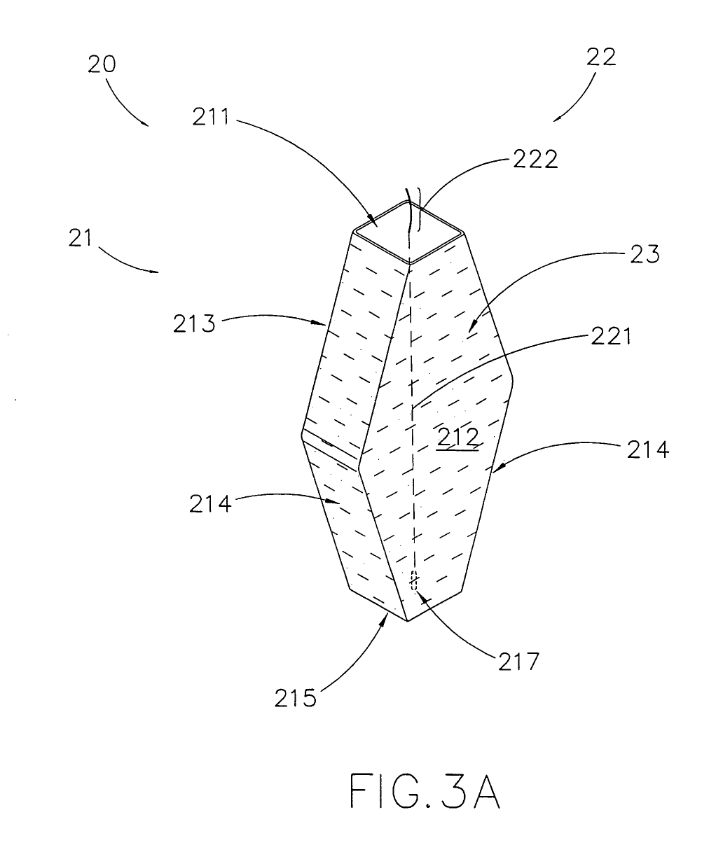

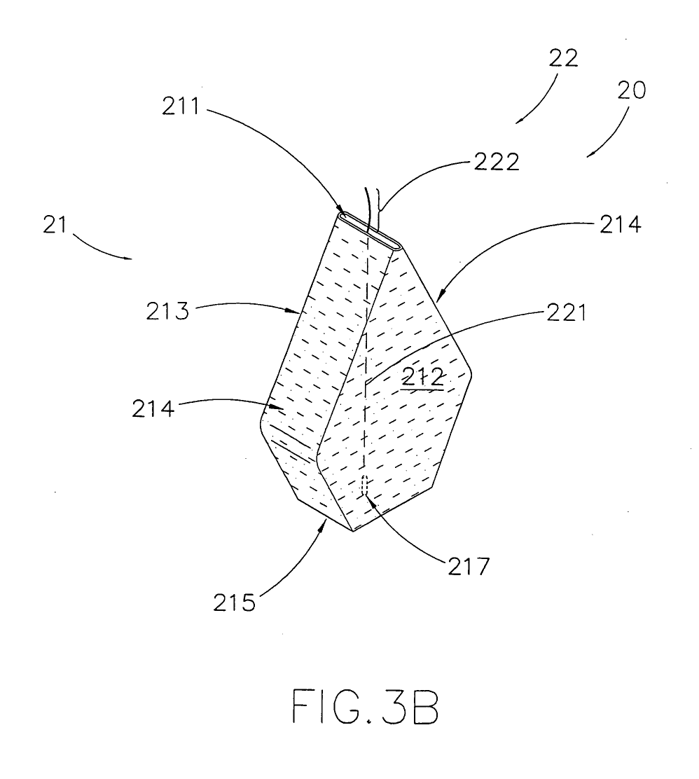

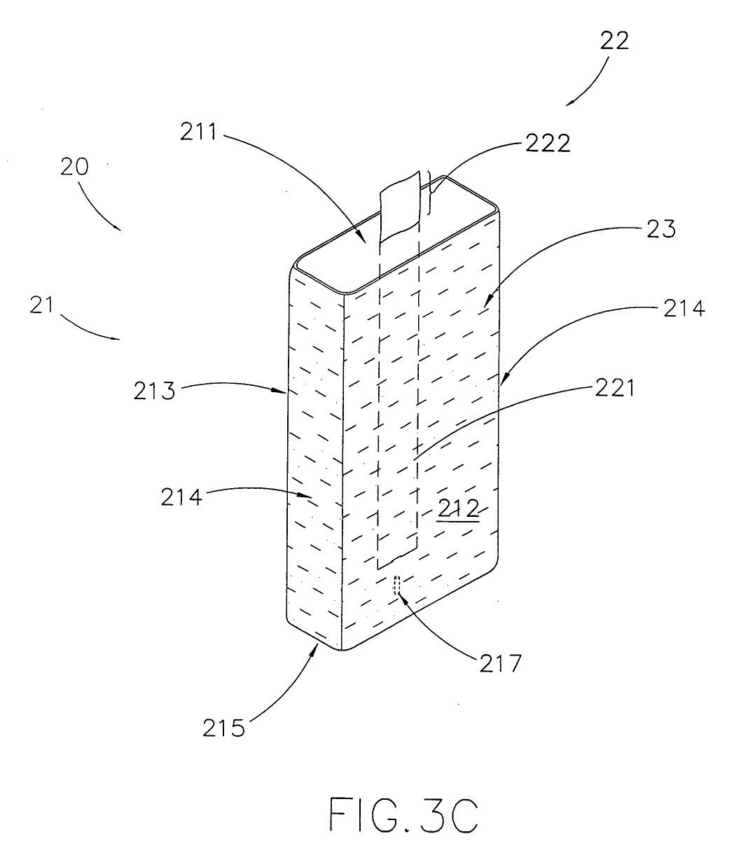

The holding seats 12 are spacedly provided in the fireproof playing area 11 at positions corresponding with the positions at which the domino members 20 are to be placed. On the other hand, each of the domino bodies 21 has a front surface 212, the top surface 211, a rear surface 213, a bottom surface 215, and a two side surfaces 214 to form a cubic structure of the domino body 21, wherein particular aesthetic patterns or appearance can be formed on each of the front surface 212, the top surface 211, the rear surface 213 and the two side surfaces 214. As a slight alternative, however, the domino bodies 21 can be made to have different cross sectional shapes for fitting particular aesthetic performance of the candle dominoes of the present invention, as shown in FIGS. 3A to 3C. In any event, the domino bodies 21 are made of wax having a predetermined color or even smell so that when they are ignited, the domino bodies 21 are adapted to release or to develop predetermined aesthetic patterns therefrom. Each of the domino bodies 21 has a holding hole 217 formed at the bottom surface 215 for the flexible holding pin 121 slidably inserting into the holding hole 217 so as to initially hold the respective domino body 21 at an upright position. It is worth mentioning that when the flexible holding pin 121 is slidably inserted into the holding hole 217, the respective domino body 21 is initially held within the fireproof playing area 11 at the upright position. Once the domino body 21 is toppled by the adjacent domino body 21, the flexible holding pin 121 is bent to allow the domino body 21 being collapsed to topple another domino body 21. When the domino body 21 is toppled, the respective flexible holding pin 121 may slide out of the holding hole 217 and return back to the original position, as shown in FIG. 2. In other words, the flexible holding pin 121 is adapted to provide enough holding force to initially hold the respective domino member 20 at the upright position. However, the pushing force applied at the domino member 20 is strong enough to bend the flexible holding pin 121 and to topple the domino member 20.

According to the present invention, the front and the rear surface 212, 213 have an area substantially larger than the area of the other surfaces (i.e. the top surface 211, the bottom surface 215, and the two side surfaces 214) so that when one of the front and the rear surface 212, 213 are toppled by the adjacent domino member 20, this domino member 20 will be brought down by that adjacent domino member 20 so as to generate the sequential illumination domino pattern on the fireproof playing area 11. As shown in FIG. 2, the bottom surface 215 of each of the domino members 20 is preferably a flat sitting surface adapted for being sat on the fireproof playing area 11 of the domino playground 10 and being retained by the respective holding seat 12. Moreover, a distance between each two domino members 20 is smaller than a height thereof so that when a first domino member 20 is toppled, the adjacent domino member 20 can be easily brought down by the first domino member 20.

The ignition element 22 of each of the domino members 20 is extended along the domino body 21 to be ignited for lighting up the corresponding domino body 21. The ignition element 22 can be made of cotton material. Alternatively, it can be made of paper or other fabric materials which are flammable for maintaining or starting ignition of the domino body 21 as a candle. It is worth mentioning that since the domino body 21 is made of wax, the domino members 20, when ignited, are effectively candles for providing continuous ignition of the domino members 20 without needing to provide separate illumination energy source, such as individual power sources. Each of the domino members 20 is then toppled to form the illumination domino pattern.

It is therefore worth mentioning that the ignition element 22 has an embedding portion 221 being embedded in the respective domino body 21 and an igniting portion 222 outwardly protruded from the respective domino body 21 for being ignited. As shown in FIGS. 3A and 3B, the ignition element 22 is made of cotton material. As shown in FIG. 3C, the ignition element 22 is made of a sheet of paper. Moreover, each of the domino members 20 can comprise a plurality of ignition elements 22 which can be ignited to form different ignition effect or to enhance the illumination domino pattern from aesthetic point of view.

In order to further optimize the utilization of the present invention, each of the domino members 20 further comprises a functional layer 23 formed on at least one outer surface of the domino member 20 for enhancing a utility feature of the present invention. For example, the functional layer 23 is preferably embodied as a citronella coating such that each of the domino members 20, when idle, can act as regular candle having the functional layer 23 coated thereon. In other words, each of the domino members 20 further comprises the functional layer 23 provided on the domino member 20 for enhancing a utility feature thereof when the domino body 21 is being burnt. In addition, the functional layer 23 can be an explosive powder embedding in the domino body 21 such that when the domino members 20 are toppled, the ignition element 22 of the domino member 20 will contact and burn the adjacent domino body 21 to generate a blasting effect at each of the domino members 20 so as to enhance the illumination domino pattern on the domino playground 10. It is worth to mention that functional layer 23 can be an outer layer of the domino body 21 or can be embedded in the domino body 21 to provide an added effect for the player or onlooker to watch, to hear, and/or to smell during the toppling action.

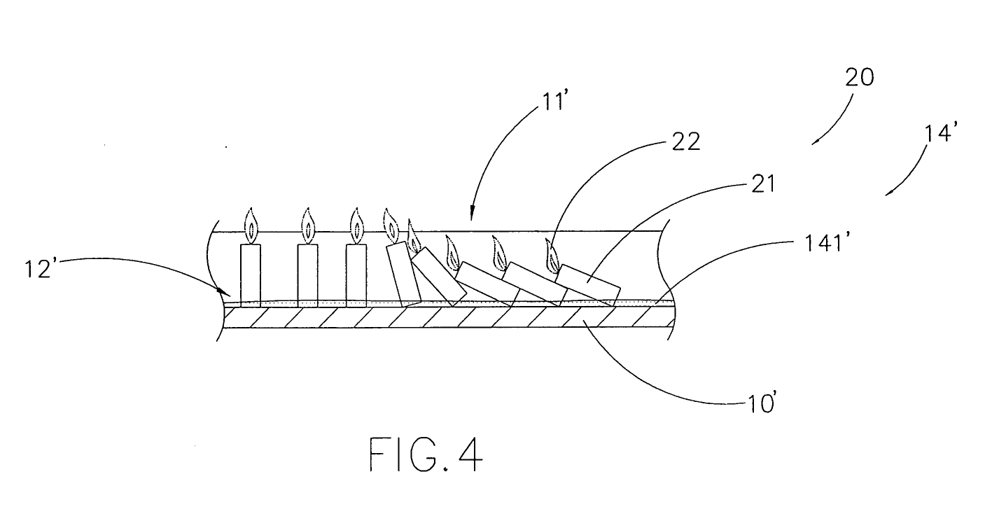

Referring to FIG. 4 of the present invention, an alternative mode of the candle dominoes set according to the preferred embodiment is illustrated. The alternative mode is similar to the preferred embodiment, except the holding seats 12′ of the domino playground 10′. According to the alternative mode of the present invention, the domino playground 10′ comprises a sand-filled station 14′ filling with sand to form a sand layer 141′ as the fireproof playing area 11′ and to define the holding seats 12′ when the bottom portions of the domino bodies 21 are being spacedly and selectively sat at the sand layer 141′.

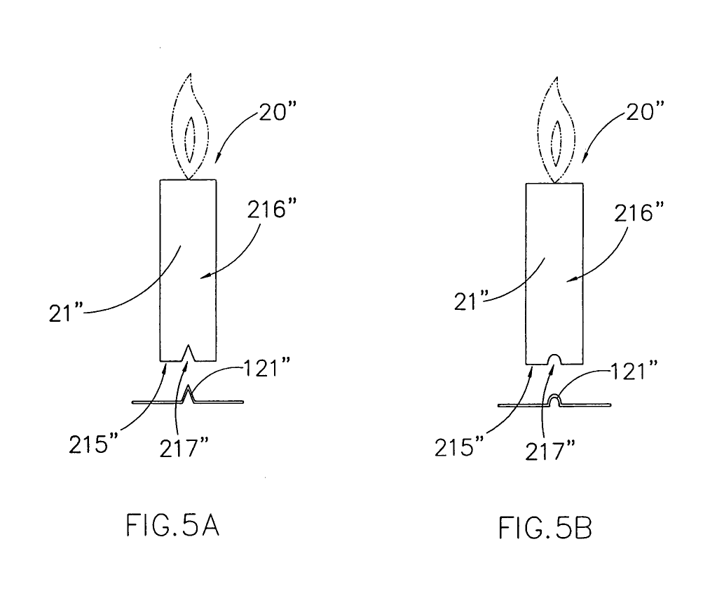

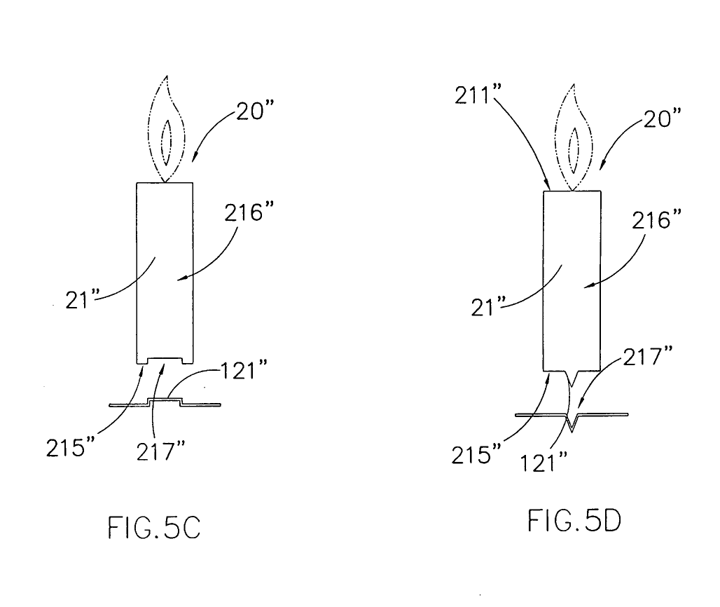

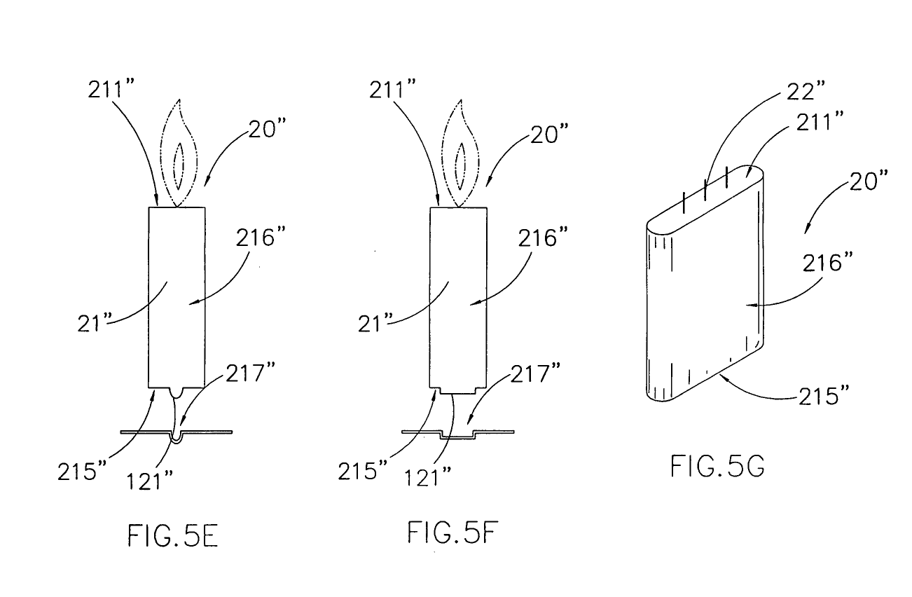

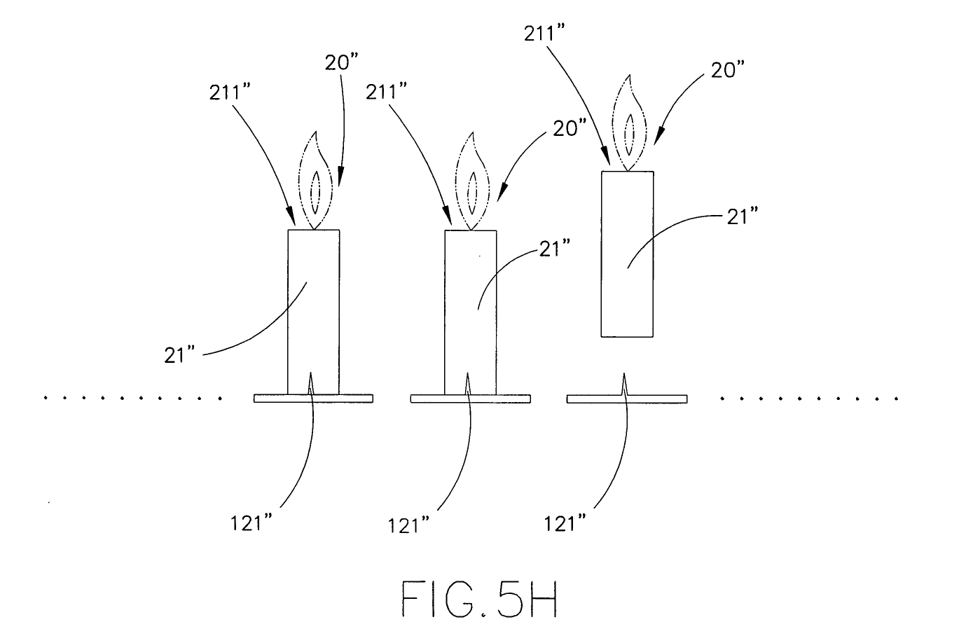

Referring to FIG. 5A to FIG. 5H of the drawings, a second alternative mode of the candle dominos set according to a preferred of the present invention is illustrated. The second alternative mode is similar to the preferred embodiment except the holding pins 121″ and the domino members 20″. According to the second alternative mode, each of the holding pins 121″ is rigidly (i.e. inflexible) extended between the domino playground 10 and the domino member 20″ to normally retain the domino member 20″ in an upright position, while allow the domino member 20″ to be toppled and brought down easily. Each of the holding pins 121″ has a predetermined cross section (as shown in FIG. 5A to FIG. 5C) for optimally facilitating easy toppling of the corresponding domino member 20″ when it is toppled by another domino member 20″.

It is worth mentioning that each of the holding pins 121″ can be integrally and upwardly extended from domino playground 10 while the holding hole 217″ is indently formed on the bottom surface 215″ of the domino body 21″ (FIG. 5A to FIG. 5C). Accordingly, the holding hole 217″ for each of the domino member 20″ is shaped and sized to correspond with the cross section of the corresponding holding pin 121″ so that the domino member 20″ normally rests on the holding pins 121″ while it can be toppled easily when brought down by adjacent domino member 20″.

On the other hand, each of the holding pins 121″ is integrally extended from a bottom surface 215″ of the corresponding domino member 20″ while the holding hole 217″ is indently formed on the corresponding holding seat 12″ (FIG. 5D to FIG. 5F). Accordingly, the holding pins 121″ are adapted to normally insert into the corresponding holding hole 217″ for retaining the domino members 20″, and when the domino members 20″ are sequentially toppled, each of the domino members 20″ is adapted to be sequentially brought down by an adjacent member 20″.

Moreover, referring to FIG. 5G of the drawings, each of the domino members 20″ has the bottom surface 215″, a top surface 211″, and a rounded side surface 216″ integrally extended between the bottom surface 215″ and the top surface 211″ to form a substantially three-dimensional geometry. It is important to mention, however, that an area of the rounded side surface 216″ is substantially larger than that of the top surface 211″ and the bottom surface 215″ so as to retain the ease of toppling of the domino member 20″. Furthermore, it is important to appreciate that each of the domino members 20″ may comprise more than one ignition element 22″.

Moreover, as shown in FIG. 5H of the drawings, when the holding seat 12″ has the holding pins 121″, a user is able to selectively insert the holding pins 121″ into the corresponding domino member 20″, wherein the holding seats 12″ are spacedly erected for being sequentially toppled when the first domino member 20″ is toppled so as to form the illumination domino pattern.

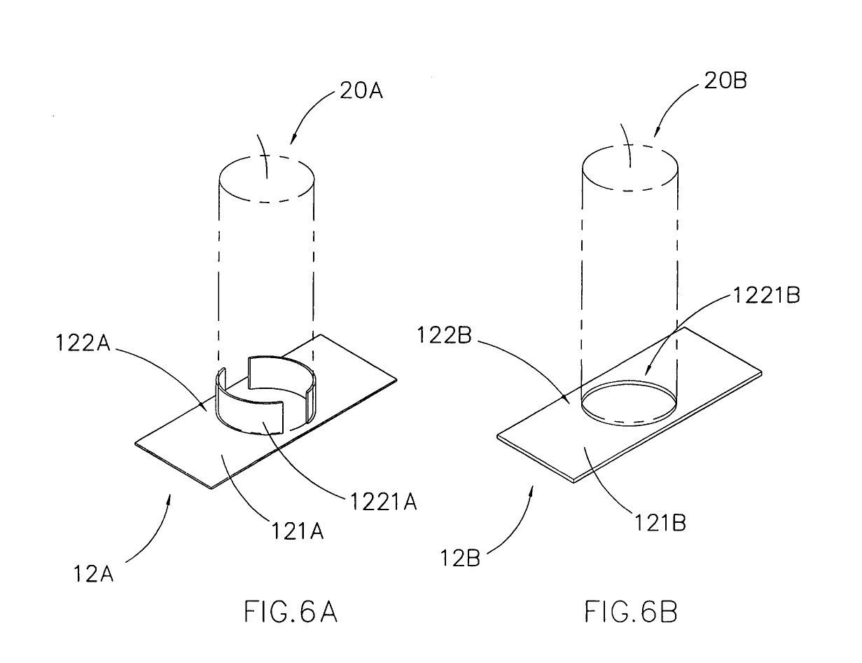

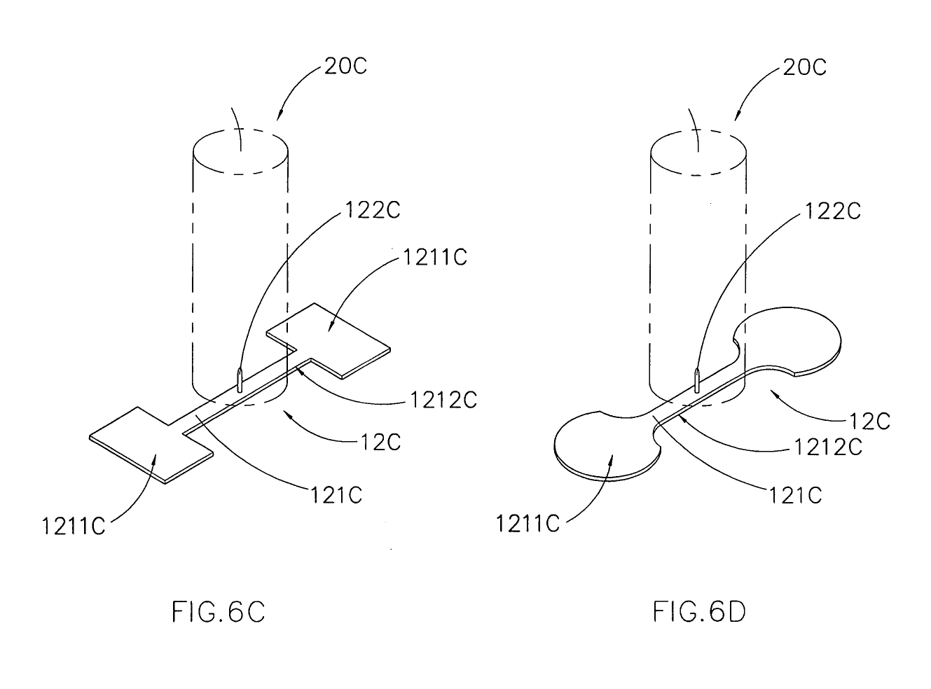

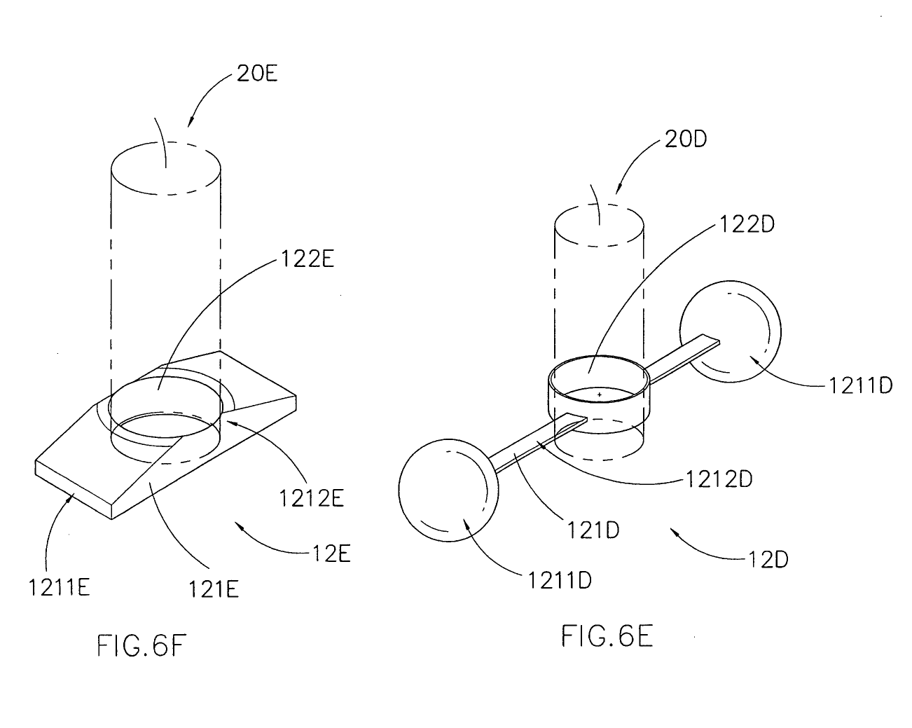

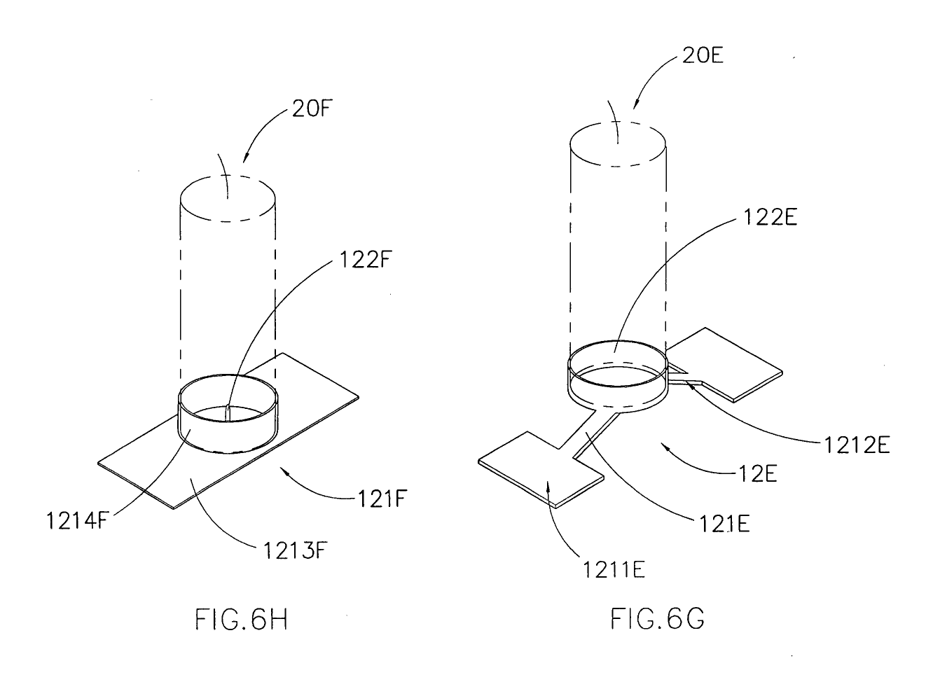

Referring to FIG. 6A to FIG. 6H of the drawings, a third alternative mode of the candle dominos set according to the preferred embodiment of the present invention is illustrated. The third alternative mode is similar to the preferred embodiment except the holding seats 12A. According to the third alternative mode of the present invention, each of the holding seats 12A comprises a holding base 121A and a domino holder 122A provided on the holding base 121A for holding the respective domino member 20A. As shown in FIG. 6A of the drawings, the holding base 121A is an elongated panel wherein the domino holder 122A comprises two holding members 1221A, each having a semi-circular cross section, upwardly and spacedly extended from the holding base 121A to define a holding cavity between the holding members 1221A for receiving a lower portion of the corresponding domino member 20A. Thus, each of the domino members 20A is adapted to be normally held by the respective holding seat 12A in a toppling manner. It is also worth mentioning that in order to retain domino members 20A of differing sizes, the holding members 1221A can be adjustably extended from the holding base 121A for holding domino members 20A of differing diameters.

It is worth mentioning that there are a number of slight alternative to the holding seats 12A. Referring to FIG. 6B of the drawings, each of the domino holders 122B of the holding seat 12B consists of a retention hole 1221B formed on the respective holding base 121B wherein the respective domino member 20B is adapted to normally sit and be retained on the retention hole 1221B.

Referring to FIG. 6C of the drawings, each of the holding bases 121C of the corresponding holding seat 12C has two enlarged side portions 1211C and a contracted mid portion 1212C extending between the two enlarged side portion 1211C, wherein the domino holder 122C is extended from the contracted mid portion 1212C of the holding base 121C for detachably engaging with the respective domino member 20C. The enlarged side portions 1211C of the holding base 121C may have different cross sections, such as square cross section (FIG. 6C), semi-circular cross section (FIG. 6D). The domino holder 122C comprises a holding pin extended from the contracted mid portion 1212C of the holding base 121C.

Referring to FIG. 6E of the drawings, each of the holding bases 121D of the corresponding seat 12D has two spherical enlarged side portions 1211D and a contracted mid portion 1212D extending between the two enlarged side portion 1211D, wherein the domino holder 122D is extended from the contracted mid portion 1212D of the holding base 121D for detachably engaging with the respective domino member 20D. The domino holder 122D comprises a circular ring extended from the contracted mid portion 1212D of the holding base 121D for holding the domino member 20D.

Referring to FIG. 6F and FIG. 6G of the drawings, each of the holding bases 121E of the corresponding holding seat 12E has two enlarged side portions and 1211E and a mid portion 1212E upwardly extended between the two enlarged side portions 1211E, wherein the domino holder 122E is provided on the mid portion 1212E of the holding base 121E to normally retain the domino member 20E at the domino holder 122E. In this alternative, the domino holder 122E contains of a retention hole formed on the mid portion 1212E of the holding base 121E (FIG. 6F). Alternatively, the domino holder 122E comprises a circular ring for holding the domino member 20E (FIG. 6G).

Referring to FIG. 6H of the drawings, the holding base 121F of the holding seat 12F comprises a base member 1213F and a base holder 1214F provided on the holding base 121F, wherein the domino holder 122F comprises a holding pin extended from the base holder 1214F to detachably engage with the corresponding domino member 20F.

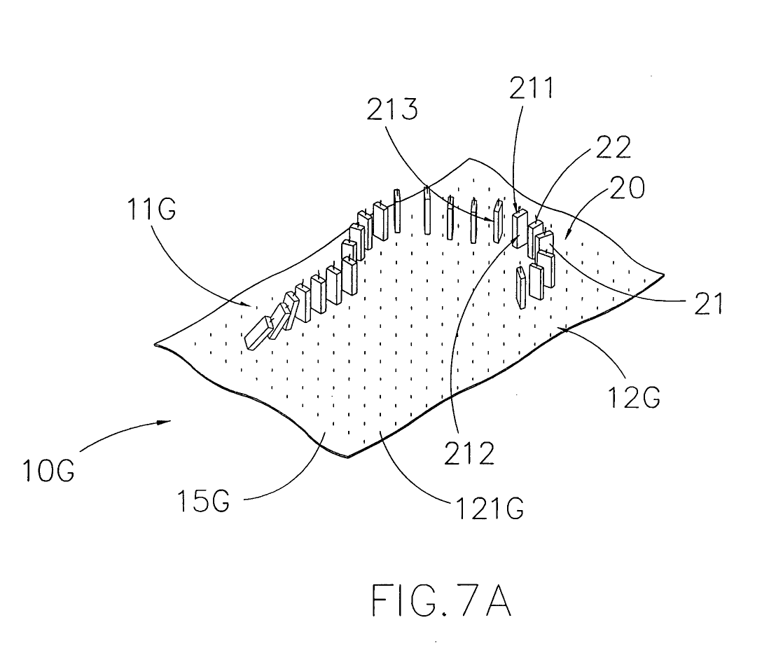

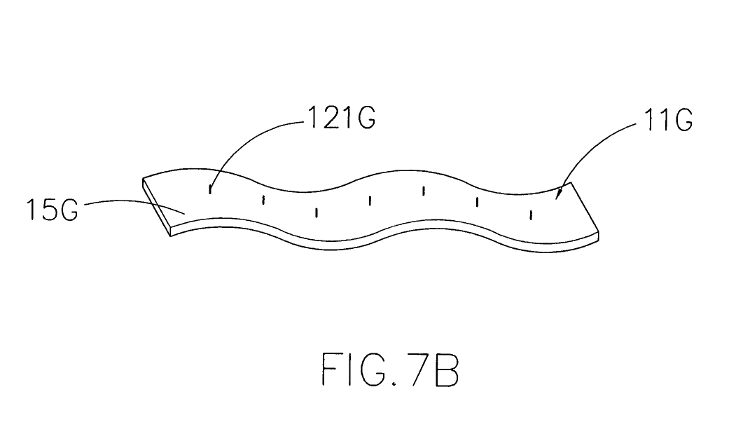

Referring to FIG. 7A to FIG. 7C of the drawings, a fourth alternative mode of the candle dominos set according to the preferred embodiment of the present invention is illustrated. The fourth alternative mode is similar to the preferred embodiment except the domino playground 10G. Referring to FIG. 7A of the drawings, the domino playground 10G comprise a playing mat 15G defining the fireproof playing area 121G within the playing mat 15G, where the holding seats 12G (i.e. the holding pins 121G) are spacedly provided within the playing mat 15G for normally holding the domino members 20 thereon. As a slight alternative, domino playground 10G can be designed and crafted to be elongated in shape so as to perform an elongated toppling pattern on the part of the domino members 20.

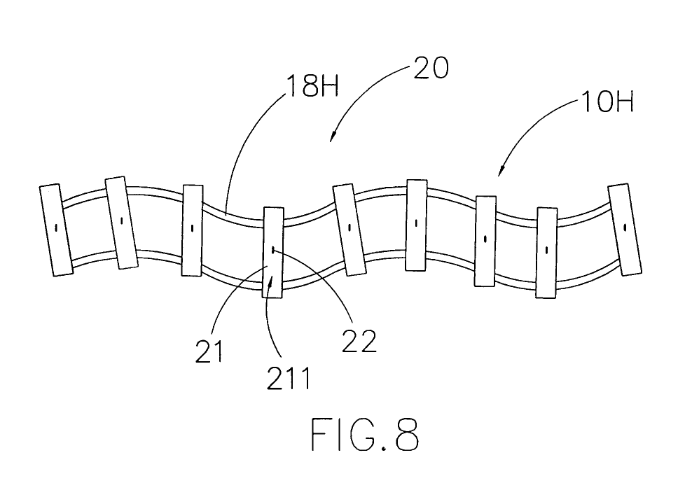

Referring FIG. 8 of the drawings, a fifth alternative mode of the candle dominos set according to the preferred embodiment of the present invention is illustrated. The fifth alternative mode is similar to the preferred embodiment except the domino playground 10H the domino playground 10H comprises a plurality of flexible guiding tracks 18H spacedly provided thereon to define the fireproof playing area 11H between the flexible guiding tracks 18H, wherein the domino members 20 are spacedly disposed on the fireproof playing area 11H along the flexible guiding tracks 18H for forming a predetermined illumination domino pattern when the domino members 20 are sequentially toppled along the flexible guiding tracks 18H.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A candle dominoes set, comprising:
a plurality of holding seats adapted for spacedly erected on a playing area; and
a plurality of domino members spacedly and selectively erected on said playing area in predetermined domino sequence to define at least one starter domino member as the first of said domino sequence and at least one final domino member as the end of said domino sequence, wherein each of said domino members comprises a wax-made domino body sitting at said one of said holding seats and an ignition element upwardly extended from a top surface of said domino body for being ignited to produce an illumination effect, wherein said holding seats initially hold said domino member at an upright position and allow said domino member to be toppled at any direction, wherein when said starter domino member is toppled to hit an adjacent domino member until said final domino member is toppled, said domino members are sequentially brought down by said previous domino members to form a predetermined illumination domino pattern on said playing area.

2. The candle dominos set, as recited in claim 1, further comprising a playing mat of a predetermined shape defining said playing area within said playing mat, where said holding seats are spacedly provided within said playing mat for normally holding said domino members thereon.

3. The candle dominos set, as recited in claim 1, further comprising a plurality of flexible guiding tracks spacedly provided on said playing area to define said playing area between said flexible guiding tracks, wherein said domino members are spacedly disposed on said playing area along said flexible guiding tracks for forming a predetermined illumination domino pattern when said domino members are sequentially toppled along said flexible guiding tracks.

4. The candle dominoes set, as recited in claim 2, wherein each of said domino bodies further has a top surface, a bottom surface, and a rounded side surface extended between said top surface and said bottom surface to form a three-dimension structure of said domino body, wherein said side surface of each of said domino member has an area substantially larger than an area of each of said top surface and said bottom Surface, so that when said front surface of one of said domino members is toppled by said rear surface of said adjacent domino member, said domino member is easily brought down by said adjacent domino member to ultimately create said sequential illumination domino pattern on said playing area.

5. The candle dominoes set, as recited in claim 2, wherein each of said domino bodies further has a top surface, a bottom surface, and a rounded side surface extended between said top surface and said bottom surface to form a three-dimension structure of said domino body, wherein said side surface of each of said domino member has an area substantially larger than an area of each of said top surface and said bottom surface, so that when said front surface of one of said domino members is toppled by said rear surface of said adjacent domino member, said domino member is easily brought down by said adjacent domino member to ultimately create said sequential illumination domino pattern on said playing area.

6. The candle dominos set, as recited in claim 4, wherein each of said holding seats comprises a holding base and a domino holder provided on said holding base for holding said respective domino member, wherein said holding base is an elongated panel and said domino holder comprises two holding members, each having a semi-circular cross section, upwardly and spacedly extended from said holding base to define a holding cavity between said holding members for receiving a lower portion of said corresponding domino member in an easily collapsible manner.

7. The candle dominos set, as recited in claim 5, wherein each of said holding seats comprises a holding base and a domino holder provided on said holding base for holding said respective domino member, wherein said holding base is an elongated panel and said domino holder comprises two holding members, each having a semi-circular cross section, upwardly and spacedly extended from said holding base to define a holding cavity between said holding members for receiving a lower portion of said corresponding domino member in an easily collapsible manner.

8. The candle dominos set, as recited in claim 4, wherein each of said holding seats comprises a holding base and a domino holder provided on said holding base for holding said respective domino member, wherein each of said domino holders consists of a retention hole formed on said respective holding base for receiving a lower portion of said respective domino member in an easily collapsible manner.

9. The candle dominos set, as recited in claim 5, wherein each of said holding seats comprises a holding base and a domino holder provided on said holding base for holding said respective domino member, wherein each of said domino holders consists of a retention hole formed on said respective holding base for receiving a lower portion of said respective domino member in an easily collapsible manner.

10. The candle dominos set, as recited in claim 4, wherein each of said holding seats comprises a holding base and a domino holder provided on said holding base for holding said respective domino member, wherein each of said holding bases has two enlarged side portions and a contracted mid portion extending between said two enlarged side portions, wherein said domino holder is extended from said contracted mid portion of said holding base for detachably engaging with said respective domino member.

11. The candle dominos set, as recited in claim 5, wherein each of said holding seats comprises a holding base and a domino holder provided on said holding base for holding said respective domino member, wherein each of said holding bases has two enlarged side portions and a contracted mid portion extending between said two enlarged side portions, wherein said domino holder is extended from said contracted mid portion of said holding base for detachably engaging with said respective domino member.

12. The candle dominoes set, as recited in claim 10, wherein each of said domino holders comprises a holding pin for detachably coupling with a bottom surface of said corresponding domino body of each of said domino members, in such a manner that when said domino member is erected on said playing area, said holding pin assists in retaining said domino members in position, and when said domino members are sequentially toppled to form said domino pattern, said holding pin allows said corresponding domino member to be toppled in an easily collapsible manner.

13. The candle dominoes set, as recited in claim 11, wherein each of said domino holders comprises a holding pin for detachably coupling with a bottom surface of said corresponding domino body of each of said domino members, in such a manner that when said domino member is erected on said playing area, said holding pin assists in retaining said domino members in position, and when said domino members are sequentially toppled to form said domino pattern, said holding pin allows said corresponding domino member to be toppled in an easily collapsible manner.

14. The candle dominos set, as recited in claim 4, wherein herein each of said holding seats comprises a holding base and a domino holder provided on said holding base for holding said respective domino member, wherein each of said holding bases has two enlarged side portions and a mid portion upwardly extended between said two enlarged side portions, wherein said domino holder, containing a retention hole, is provided on said elevated mid portion of said holding base to normally retain said domino member at said elevated domino holder in an easily collapsible manlier.

15. The candle dominos set, as recited in claim 5, wherein herein each of said holding seats comprises a holding base and a domino holder provided on said holding base for holding said respective domino member, wherein each of said holding bases has two enlarged side portions and a mid portion upwardly extended between said two enlarged side portions, wherein said domino holder, containing a retention hole, is provided on said elevated mid portion of said holding base to normally retain said domino member at said elevated domino holder in an easily collapsible manner.

16. The candle dominos set, as recited in claim 4, wherein each of said holding seats comprises a holding base and a domino holder provided on said holding base for holding said respective domino member, wherein said holding base comprises a base member and a circular base holder provided on said holding base, wherein said domino holder further comprises a holding pin extended from said base holder to detachably engage with said domino member.

17. The candle dominos set, as recited in claim 5, wherein each of said holding seats comprises a holding base and a domino holder provided on said holding base for holding said respective domino member, wherein said holding base comprises a base member and a circular base holder provided on said holding base, wherein said domino holder further comprises a holding pin extended from said base holder to detachably engage with said domino member.

18. The candle dominoes set, as recited in claim 12, wherein each of said domino body has a holding hole formed at said bottom surface for said holding pin slidably inserting into said holing hole so as to initially hold said domino body at an upright position.

19. The candle dominoes set, as recited in claim 13, wherein each of said domino body has a holding hole formed at said bottom surface for said holding pin slidably inserting into said holing hole so as to initially hold said domino body at an upright position.

20. The candle dominoes set, as recited in claim 16, wherein each of said domino body has a holding hole formed at said bottom surface for said holding pin slidably inserting into said holing hole so as to initially hold said domino body at an upright position.

21. A holding seat adapted for holding a domino member in a toppling manner, comprising:
a holding base; and
a domino holder provided on said holding base for holding said domino member, wherein when a plurality of said domino members are spacedly erected on a plurality of said holding seats to form predetermined domino sequence to define at least one starter domino member as the first of said domino sequence and at least one final domino member as the end of said domino sequence, said holding seats initially hold said domino member at an upright position and allow said domino member to be toppled at any direction, in such a manner that when said starter domino member is toppled to hit an adjacent domino member until said final domino member is toppled, said domino members are sequentially brought down by said previous domino members to form a predetermined illumination domino pattern on said playing area.

22. The holding seat, as recited in claim 21, wherein said holding base is an elongated panel and said domino holder comprises two holding members, each having a semi-circular cross section, upwardly and spacedly extended from said holding base to define a holding cavity between said holding members for receiving a lower portion of said corresponding domino member in an easily collapsible manner.

23. The candle dominos set, as recited in claim 21, wherein each of said domino holders consists of a retention hole formed on said respective holding base for receiving a lower portion of said respective domino member in an easily collapsible manner.

24. The candle dominos set, as recited in claim 21, wherein each of said holding bases has two enlarged side portions and a contracted mid portion extending between said two enlarged side portions, wherein said domino holder is extended from said contracted mid portion of said holding base for detachably engaging with said respective domino member.

25. The candle dominoes set, as recited in claim 21, wherein said domino holder comprises a holding pin for detachably coupling with a bottom surface of said corresponding domino body of each of said domino members, in such a manner that when said domino member is erected on said holding seat, said holding pin assists in retaining said domino members in position, and when said domino member is sequentially toppled to form said domino pattern, said holding pin allows said corresponding domino member to be toppled in an easily collapsible manner.

26. The candle dominos set, as recited in claim 21, wherein each of said holding bases has two enlarged side portions and a mid portion upwardly extended between said two enlarged side portions, wherein said domino holder, containing a retention hole, is provided on said elevated mid portion of said holding base to normally retain said domino member at said elevated domino holder in an easily collapsible manner.

27. The candle dominos set, as recited in claim 21, wherein said holding base comprises a base member and a circular base holder provided on said holding base, wherein said domino holder further comprises a holding pin extended from said base holder to detachably engage with said domino member.
